(19) United States
(12) Patent Application Publication
(10) Pub. No.: US 2004/0103851 A1
(43) Pub. Date: Jun. 3, 2004

(54) Nectar feeder incorporating fluid transport

(76) Inventor: Lynn L. Hunter, Parker, CO (US)

Correspondence Address: TIMOTHY J MARTIN, PC, 9250 W 5TH AVENUE, SUITE 200, LAKEWOOD, CO, 80226, US

(21) Appl. No.: 10/446,179

(22) Filed: May 28, 2003

Related U.S. Application Data
(60) Provisional application No. 60/384,710, filed on May 30, 2002.

(51) Int. Cl. A01K 7/00

(52) U.S. Cl. 119/72

(57) ABSTRACT

A bird feeder to be suspended from a support structure is provided, including a hanger member and a feeder member. The hanger member includes a bracket piece that engages the support structure and a frame piece connected thereto that forms an opening for receiving the feeder member. The feeder member has a body with an interior defining a reservoir and a mouth communicating with the interior. The feeder member also includes an outwardly extending flange structure operative to engage the frame piece, which may be shaped as four lobes configured as petals of a flower. The bird feeder may include a tube member with a hollow portion extending into the reservoir, which may be shaped to resemble the pistil of a flower. In addition, a fluid transport device, such as a wick, may be received by the hollow portion to facilitate the bird's access to the fluid in the reservoir.

### FIELD OF THE INVENTION

The present invention generally relates to nectar feeders for hummingbirds, orioles, butterflies and the like, and methods for feeding the same. More particularly, the present invention is directed to feeders for providing nectar solutions for consumption by creatures such as hummingbirds, orioles and butterflies. Specifically, the present invention is directed to feeders incorporating a fluid transport device for transporting nectar from a reservoir to an aperture adapted to dispense nectar for consumption.

### BACKGROUND OF THE INVENTION

Bird-watching is a highly prevalent past-time in both urban and rural areas. The world is full of birds of numerous varieties in an astounding array of colors and designs. Many people enjoy viewing birds of various types, and an industry has grown up around products directed to improving the ability of persons to get close to birds. On one hand, many people venture into the outdoors, where binoculars and spotting scopes may be utilized to better view various birds in their natural habitats. Such an approach requires a certain degree of skill, however, in finding and spotting various species of birds. Another approach utilizes various means of attracting birds to one's residence or a desired viewing location, such as adjacent a home porch or window, where birds may be viewed at one's leisure.

In particular, the art of using bird feeders, bird baths, and the like has arisen to attract birds of various types to one's home. Different types of feeders have been developed, which each dispense foodstuffs that are preferred by a selected variety of bird which a person might desire to view. For example, seeds, grains, suets, and nectars are common foodstuffs that can be dispensed by a selected type of feeder.

Hummingbirds are one particularly interesting type of bird that persons commonly desire to view. The hummingbird family is found only in the Americas, and includes more than 300 species of birds. Hummingbirds are known for their rapid flight and their ability to hover in the air, such as at a food source, and fly backwards (the only birds capable of doing so). In particular, they feed on nectar and tiny insects found within flowers, generally hovering in front of a flower as they reach for food with long, extensible tongues. Their rapid wing beat produces a hum, and they are generally brightly colored and iridescent, thus particularly enjoyable to view. Many male hummingbirds have metallic green coloring with brightly colored throats, which are often a glittering red, blue, or emerald. They are often seen hovering or darting, and have been known to reach speeds up to 60 miles per hour in the air, beating their wings at 50 to 75 beats per second.

Various types of feeders have been developed to attract hummingbirds to a particular location for viewing. Many people hang such feeders from porches or backyard trees, so as to be able to watch various brightly colored birds arrive and depart, hovering or sometimes perching at the feeder in the interim to feed. Due to the enormous energy requirements of their particular flight patterns, hummingbirds require virtually constant feeding of high-sugar content foodstuffs.

Accordingly, it is generally common to provide a nectar-like solution for hummingbirds from a brightly colored feeder designed to simulate the colors of flowers to which hummingbirds are generally attracted, such as red in particular. Such feeders can additionally be utilized by orioles and butterflies, which one may also desire to attract and view by providing appropriate feeders and nectars therefor. It is also desirable that such feeders have an aesthetically appealing look, so as not to detract from the appearance of the structure or locale in which the feeder is placed.

Such feeders generally include a reservoir and one or more openings from which a hummingbird or other creature can access the nectar. Flower designs, such as petals and the like, are generally provided to simulate a more natural nectar source for the consuming creatures. Many designs for such feeders provide an inverted reservoir that has openings located below the level of the solution such that the solution is continually provided to the openings for access by the consuming creatures. However, because of the inverted design of such feeders, movement thereto—such as in the process of retrieving the feeder from a support—can often cause a substantial amount of the nectar solution to spill out of the feeder. Additionally, wind may cause a feeder to sway on the flexible strap often used for support, which also can cause a substantial amount of nectar solution to spill from the feeder. In addition to causing unnecessary waste of nectar solution, this situation often creates a sugary residue on the ground or other surface below the feeder, which can attract insects and cause other undesirable unsightliness.

Accordingly, other designs for such nectar feeders provide an upright reservoir having an access opening thereto that is located above the level of the nectar solution, such that spills therefrom are reduced. However, difficulties arise as the nectar solution is depleted such that the consuming creature becomes unable to reach through the opening the remainder of the nectar in the bottom of the reservoir. Accordingly, it may become necessary for the feeder to be continually replenished with nectar, so as to raise the level thereof to a level from which the nectar can be accessed through the opening. Where a feeder is being rapidly depleted of nectar by numerous visiting creatures, it thus may become necessary to frequently replenish the nectar to a reachable level.

Accordingly, it can be seen that there remains a need to provide a new and improved nectar feeder that incorporates a means for transporting nectar solution from a reservoir to an opening through which the nectar is accessed by consuming creatures, such as hummingbirds, orioles and butterflies. There is also a need to provide an aesthetically pleasing nectar feeder having an upright reservoir that requires a reduced frequency of refilling. There is further a need to provide a nectar feeder having appropriate attracting indicia thereon, such as flower blossoms for attracting hummingbirds and butterflies and orange slices for attracting orioles. The present invention is directed to meeting these needs.

### SUMMARY OF THE INVENTION

It is an object of the present invention to provide a new and useful nectar feeder for providing nectar to consuming creatures such as hummingbirds, orioles and butterflies.

It is another object to provide a nectar feeder having aesthetically appealing design elements useful for attracting creatures to be viewed.

A still further object is to provide a nectar feeder that minimizes spillage of the contents therein while increasing available nectar for consumption.

Yet another object is to provide a nectar feeder requiring reduced frequency of refilling.

A still further object is to provide a nectar feeder that incorporates a means for transporting nectar solution from a reservoir to an opening through which the nectar is accessed by consuming creatures.

It is yet another object to provide a method for feeding birds utilizing an aesthetically appealing apparatus therefor.

According to the present invention, then, a bird feeder that may be suspended from a support structure is provided. The bird feeder generally includes a hanger member and a feeder member. The hanger member includes a bracket piece connected to a frame piece and engages the support structure to secure the hanger member thereto. It may be J-shaped whereby a first leg section is joined to a shorter second leg section by an arcuate intermediate section. The first leg section may terminate in a hook structure while the terminal end of the second leg section is connected to the frame piece.

The frame piece forms an opening and is connected to the bracket piece. Preferably, the frame piece is in a plane that is generally perpendicular to the first and second leg sections and located between the end of the second leg section and the first leg section, yet is unconnected to the first leg section. The frame piece may be an enclosed annulus, but is not limited to this configuration.

The feeder member is adapted to be received by the hanger member in a mounted state. The feeder member has a body with an interior defining a reservoir and a mouth communicating with the interior such that food for a bird may be placed in the interior through the mouth. The feeder member also includes an outwardly extending flange structure operative to engage the frame piece that may be shaped to have four lobes configured as petals of a flower.

As contemplated, the bird feeder of the present invention may further include a tube member with a hollow tubular portion received through the mouth of the feeder body and extending into the reservoir. The tube member preferably includes a radially outwardly extending lip to engage an upper portion of the body that is shaped to resemble the pistil of a flower. In addition, a fluid transport device, such as a wick, may be received by the hollow tubular portion of the tube member to facilitate the consuming bird's access to the fluid in the reservoir.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a front view in perspective of a nectar feeder according to the present invention;

FIG. 2 is a side view in elevation of the hanger member.

FIG. 3 is a top plan view of the nectar feeder of FIG. 1;

FIG. 4 is a partially exploded cross-sectional view taken about lines 4-4 in FIG. 3;

FIG. 5 is a cross-sectional side view of the nectar feeder of FIG. 1 absent the hanger, and showing a small amount of nectar in the bottom of the reservoir thereof; and

FIG. 6 is a partially exploded side view in elevation of the nectar feeder of FIG. 1.

### DETAILED DESCRIPTION OF THE EXEMPLARY EMBODIMENTS

The present invention relates to nectar feeders that are adapted to dispense a foodstuff, such as a nectar solution, to various types of creatures, such as hummingbirds, orioles, and butterflies. In particular, the present invention relates to nectar feeders having a reservoir for receiving a nectar solution and including at least one opening for accessing an interior of the reservoir, where the opening is located above the level of solution when the reservoir is filled therewith and the feeder is placed in its operative position. Specifically, the present invention relates to feeders that may be formed of blown-glass or other material such as plastic or the like, which are formed to replicate a flower blossom, orange slice or other design appropriate for attracting hummingbirds, orioles, butterflies or other creatures to the feeder. A fluid transport device, such as a wick formed of a fluid absorbing material such as cloth, sponge, or the like, or a straw, capillary tube, or other transport mechanism is provided for bringing fluid in the reservoir to a location from which the fluid can be accessed from an opening adapted to provide such fluid to the consuming creature. As contemplated, the nectar feeder may be received by a hanger, which allows the feeder to be suspended from a support structure in a place that is suitable for attracting birds.

While the present invention is specifically described herein with respect to blown-glass feeders of the type shown and described, it should be appreciated that the present invention is applicable to various other types and configurations of feeders for which transport of a nectar solution in a reservoir to an appropriate aperture or feeding position is desirable.

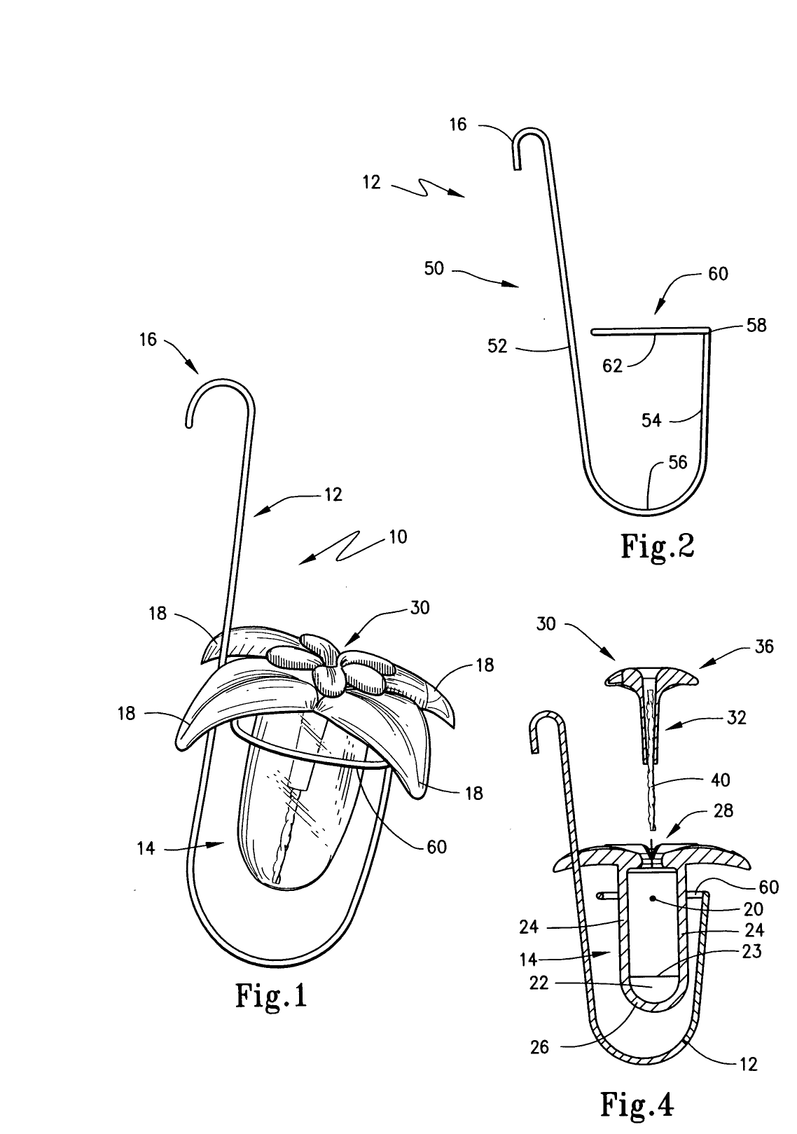

Turning to FIG. 1, it can be seen that bird feeder 10 according to the present invention includes a hanger 12 sized and adapted to support a feeder body 14. Hanger 12 includes a hook structure 16 adapted to suspend hanger 12 from an appropriate support structure as known in the art. Hanger 12 may be formed of any material suitable for supporting the weight of the feeder body such as metal, wood, plastic, and the like. Preferably, hanger 12 supports feeder body 14 so that it has a forward lean or tilt such that the feeder body is at a slight angle relative to the support surface.

With reference to FIG. 2, hanger 12 is formed of a bracket piece 50 and a frame piece 60. As shown, bracket piece 50 is J-shaped and includes a first leg section 52 and a second leg section 54, which are joined by an arcuate intermediate section 56. First leg section 52 terminates in hook structure 16, which may be use to suspend hanger 12 from a support structure. However, as should be understood, a loop or other structure readily available in the art may be used to suspend the hanger.

Second leg section 54 terminates at an end 58 and is connected to frame piece 60. As shown, frame piece 60 need not be directly connected to first leg section 52, which promotes the tilting of the bird feeder when received in the hanger and suspended from the support structure. Second leg section 54 and frame piece 60 are preferably formed as a one-piece construction such that hanger 12 is one continuous and integral piece.

Frame piece 60 forms an opening 62 that is sized and adapted to receive feeder body 14 as is perhaps best shown in FIGS. 1 and 6. Opening 62 can be configured as an annulus, or any other desired shape that is able to support the feeder body. For example, opening 62 may be configured as a triangle or a rectangular or various other desired configurations and may be either an open or enclosed structure.

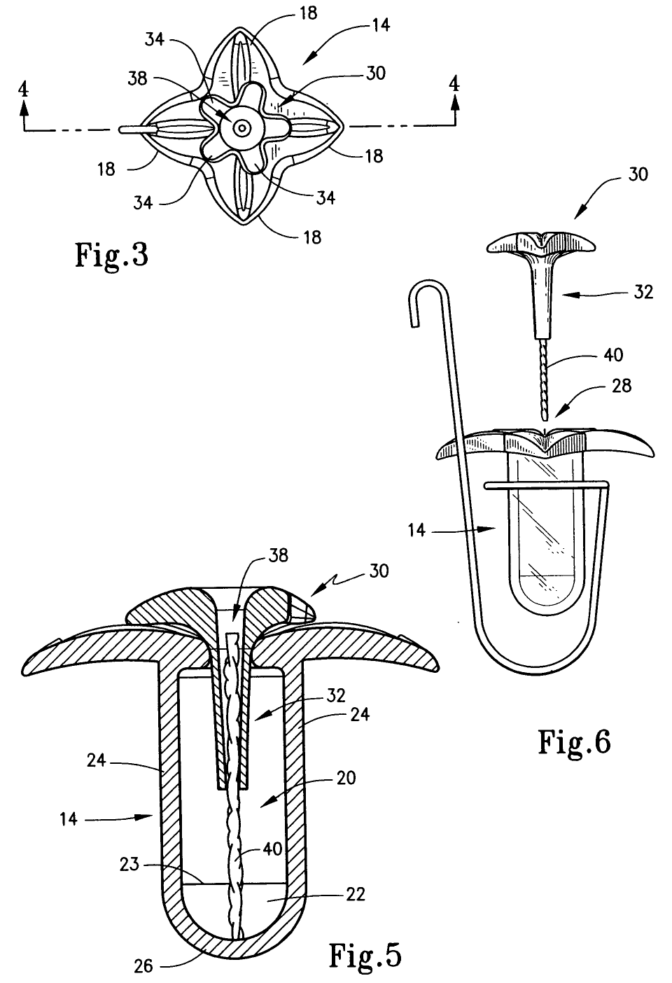

With reference to FIGS. 1 and 3, feeder body 14 includes a plurality of radially extending lobes 18 that are designed to simulate the petals of a flower. Lobes 18 form a flange structure operative to engage frame 60 so that feeder body 14 is supported thereby. While four lobes or petal structures are shown, it should be appreciated that any number and configuration of petal structures as appropriate can be provided to simulate any desired flower blossom shape or as needed so as to be seated on the frame and supported thereby. Moreover, lobes 18 may be of various colors or combinations thereof, as appropriate. Here, feeder body 14 is preferably formed of blown glass, and may include various glass compositions therein thereby to provide internal design characteristics, such as the inclusion of various colors or shapes within petal structures 18, as known in the art of glass blowing. Alternatively, feeder body 14 may be formed of various other materials, such as various plastics or the like, and may be molded or formed as known in the art.

As apparent with reference to FIGS. 4 and 5, feeder body 14 is formed to include a reservoir 20 adapted to receive a selected volume of fluid, such as a nectar solution 22. Reservoir 20 preferably extends below lobes 18. Reservoir 20 is defined by a surrounding sidewall 24 and a base 26. Sidewall 24 may be of a generally cylindrical shape or may be of other configurations, such as box shaped or the like. Similarly, base 26 may be generally hemispherical or domed, or may be of other configurations such as planar or peaked. Preferably, sidewall 24 and base 26 are integrally formed, such as from blown glass or other materials as described above. Sidewall 24 and base 26 may further be integrally formed with lobes 18, such that feeder body 14 is formed from a single piece of material, such as from blown glass as described above. However, it should be understood that lobes 18 may be formed separately from reservoir 20, and lobes 18 may be connected to sidewall 24 by various means as known in the art.

With reference to FIGS. 4 and 6, it can be seen that feeder body 14 includes a central opening 28 in communication with reservoir 20 and through which reservoir 20 can be accessed. Opening 28 can be used to fill reservoir 20 with nectar. It should be appreciated that feeder body 14 may include multiple openings, although a single central opening to replicate the center of a flower is preferred. Opening 28 is disposed above reservoir 20 such that when reservoir 20 is filled with nectar solution 22, opening 28 is located above an upper surface 23 of nectar 22.

With reference to FIGS. 1 and 3-6, it can be seen that feeder 10 includes an optional central pistil portion 30 which is sized and adapted to be received by central opening 28. Pistil portion 30 generally replicates the look of a stigma and style of a flower, and includes a generally longitudinally extending tube 32 and a plurality of radially extending projections 34 disposed around an upper end portion 36 thereof. Pistil portion 30 and petal structures 18 together simulate the look of a flower blossom. As can be appreciated from FIG. 5, when pistil portion 30 is seated in central opening 28, access to reservoir 20 is through the central passage 38 of tube 32. Pistil portion 30 may also be formed of blown glass or other material as described above, and is preferably of a color different than a color of petal structures 18 so as to contrast therewith. It should be appreciated that pistil portion 30 may function as a bee and ant guard that limits the ability of bees, ants and other insects to enter reservoir 20.

As apparent from FIGS. 4-6, a fluid transport device 40 is provided which extends between central opening 28 and reservoir 20 thereby to transport nectar 22 from reservoir 20 to central opening 28. When pistil portion 30 is present, fluid transport device 40 extends through tube 32 thereof thereby to transport nectar through central passage 38 of pistil portion 30. Nectar from the bottom of reservoir 20 thus is transported to near the top of pistil portion 30 (or feeder body 14 when pistil portion 30 is not present) and becomes accessible by consuming creatures such as hummingbirds, orioles and butterflies.

It should be appreciated that fluid transport device 40 may be provided in various configurations adapted to transport fluid from one end to another thereof. For example, fluid transport device 40 may be provided as a “wick” of various fluid absorbing materials, such as string, cloth, sponge or the like, or may be configured as a straw or small-diameter capillary tube formed from glass, plastic or the like. It should be appreciated that when fluid transport device 40 is configured as a glass capillary tube, fluid is transported from reservoir 20 via capillary rise as understood in the art.

From the foregoing, it should be apparent that the present invention lends itself to a method of attracting and feeding creatures such as hummingbirds, orioles and butterflies. In particular, a feeder having a reservoir may be at least partially filled through a mouth thereof with a fluid foodstuff, such as a nectar solution for hummingbirds. The feeder preferably includes adjacent the mouth thereof the design of a flower, orange slice or other appropriate attracting indicia. A fluid transport device, such as a wick or capillary, is provided that extends from a region near the mouth of the reservoir into the nectar solution, where the fluid transport device is operative to transport the nectar to the reservoir mouth or to a region near the reservoir mouth that is accessible to the consuming creatures. The feeder may then be placed in a desired location for feeding.

Accordingly, the present invention has been described with some degree of particularity directed to the exemplary embodiments of the present invention. It should be appreciated, though, that modifications or changes may be made to the exemplary embodiments of the present invention without departing from the inventive concepts contained herein.

I claim:

1. A bird feeder adapted to be suspended from a support structure against the force of gravity, comprising:
(A) a hanger member adapted to engage the support structure including
(1) a bracket piece adapted to secure said hanger member to the support structure and
(2) a frame piece connected to said bracket piece and forming an opening; and
(B) a feeder member adapted to be received by said hanger member in a mounted state and including
(1) a body having an interior defining a reservoir with a mouth communicating with the interior such that food for a bird may be placed in the interior through the mouth and
(2) an outwardly extending flange structure operative to engage said frame piece when in the mounted state such that said feeder member is supported by said frame piece.

2. A bird feeder according to claim 1 including a tube member having an elongated hollow tubular portion sized and adapted to be matably received through the mouth so as to extend into the reservoir in a received state and a radially outwardly extending lip operative to engage an upper portion of said body in the received state whereby said tube member is supported thereby relative to said feeder member.

3. A bird feeder according to claim 2 including a fluid transport device adapted to be received in said hollow tubular portion and extend into the reservoir.

4. A bird feeder according to claim 3 wherein said fluid transport device is a wick.

5. A bird feeder according to claim 1 wherein said frame piece is formed as an annulus.

6. A bird feeder according to claim 1 wherein said bracket piece includes a J-shaped portion connected to said frame piece, said J-shaped portion having a first leg section of a first length and second leg section of a second length that is shorter than said first length, said first and second leg section being joined by an intermediate section.

7. A bird feeder according to claim 6 wherein said first leg section terminates in a hook structure.

8. A bird feeder according to claim 6 wherein said frame piece is connected to a terminal end of said second leg section.

9. A bird feeder according to claim 8 wherein said frame piece is in a plane that is generally perpendicular to said first and second leg sections and is located between the end of said second leg section and said first leg section yet is unconnected to said first leg section.

10. A bird feeder according to claim 6 wherein said intermediate section is arcuate.

11. A bird feeder according to claim 1 wherein said flange structure is shaped to have a plurality of lobes configured as petals of a flower.

12. A bird feeder according to claim 11 wherein there are four said lobes.

13. A bird feeder adapted to be suspended from a support structure against the force of gravity, comprising:
(A) a hanger member including
(1) a J-shaped bracket adapted to suspend said hanger member from the support structure and
(2) an annular frame connected to said J-shaped bracket and forming an opening;
(B) a feeder member adapted to be received in said hanger member in a mounted state and including
(1) a body having an interior defining a reservoir with a mouth communicating with the interior such that food for a bird may be placed in the interior through the mouth and
(2) an outwardly extending flange structure operative to engage said frame when in the mounted state such that said feeder member is supported by said frame; and
(C) a tube member having an elongated hollow tubular portion sized and adapted to be matably received through the mouth and extend into the reservoir in a received state and a radially outwardly extending lip operative to engage an upper portion of said body in the received state whereby said tube member is supported thereby relative to said feeder member.

14. A bird feeder according to claim 13 wherein said J-shaped bracket includes a first leg section of a first length and second leg section of a second length that is shorter than said first length, said first and second leg section being joined by an intermediate section.

15. A bird feeder according to claim 14 wherein said intermediate section is arcuate.

16. A bird feeder according to claim 14 wherein said first leg section terminates in a hook structure.

17. A bird feeder according to claim 14 wherein said frame is connected to an end of said second leg section.

18. A bird feeder according to claim 17 wherein said frame is in a plane that is generally perpendicular to said first and second leg sections and is located between the end of said second leg section and said first leg section yet is unconnected to said first leg section.

19. A bird feeder according to claim 13 wherein said flange structure is shaped to have a plurality of lobes configured as petals of a flower.

20. A bird feeder according to claim 13 wherein said lip is shaped to resemble the pistil of a flower.

21. A bird feeder according to claim 13 wherein said annular frame is enclosed.

22. A bird feeder according to claim 13 including a fluid transport device adapted to be received in the body of said feeder member.

23. A bird feeder according to claim 22 wherein said fluid transport device is a wick.
